(19) United States
(12) Patent Application Publication
(10) Pub. No.: US 2026/0228911 A1
(43) Pub. Date: Aug. 6, 2026

(54) SYSTEMS AND METHODS FOR UNDER-TRAILER SENSING

(71) Applicant: Robotic Research OpCo, LLC, Clarksburg, MD (US)

(72) Inventor: Alberto Daniel LACAZE, Potomac, MD (US)

(21) Appl. No.: 19/149,160

(22) PCT Filed: Jan. 22, 2024
(86) PCT No.: PCT/US24/12453

§ 371 Date: Jul. 18, 2025

Related U.S. Application Data
(60) Provisional application No. 63/480,731, filed on Jan. 20, 2023.

(51) Int. Cl. G06T 7/73; B60W 30/09; G01S 17/88; G06V 20/58; H04N 23/54; H04N 23/695

(52) U.S. Cl. CPC G06T 7/74; G01S 17/88; H04N 23/54; H04N 23/695; B60W 30/09; B60W 2420/403; B60W 2420/408; B60W 2530/203; G06T 2207/30252; G06V 20/58

(57) ABSTRACT

Systems, apparatus, methods, and articles of manufacture for under-trailer sensing that is utilized to guide and/or conduct trailer maneuvers.

### CROSS-REFERENCE TO RELATED APPLICATIONS

The present application claims the benefit of, and priority to, and is a non-provisional of, U.S. Provisional Patent Application No. 63/480731, filed Jan. 20, 2023, the entire contents of the disclosure of which are hereby incorporated by reference herein.

### BACKGROUND

While there are various instances where autonomous vehicle operation may be utilized to maneuver trailers, the application of autonomous technology is generally limited by policies that prevent deployment in cases where there is no visibility behind the trailer. Current systems overcome these limitations by either utilizing a human observer or by mounting cameras or sensors on the rear of the trailers. The presence of a human observer guiding the backing procedure presents obvious safety concerns. Sensors on the trailers are typically mounted on the trailer at an elevated position, and thus may not provide a clear view of the back of the trailer particularly in areas close to the ground. In addition, the variations in trailer design and dimensions add presents issues with respect to the geometrical parameters associated with backing up of an individual trailer.

### SUMMARY

In one illustrative embodiment, an automated trailer maneuvering system comprises a trailer and a vehicle coupled to the trailer with vehicle including (i) a sensor coupled to have a field of view oriented to encompass an area underneath of the trailer, (ii) an electronic processing device, and (iii) a memory storing instructions that when executed by the processing device result in: receiving, from the sensor and at a first time, first image data of the area underneath of the trailer; computing, utilizing the first image data and a mathematical model, a first value for a first metric of the trailer; moving, by the vehicle, the trailer; receiving, from the sensor and at a second time, second image data of the area underneath of the trailer; computing, utilizing the second image data and the mathematical model, a second value for the first metric of the trailer; computing a difference between the first and second values for the first metric of the trailer; and guiding, based on the computed difference between the first and second values for the first metric of the trailer, further movement of the trailer.

In embodiments, the sensor is coupled to have the field of view oriented to encompass the area underneath of the trailer by selectively deploying the sensor from a first position that does not have the field of view to a second position that does have the field of view.

In embodiments, the sensor is deployed via an automatically adjustable sensor mount coupled to a rear of the vehicle.

In some embodiments, the sensor is deployed in response to a detection of a backing of the vehicle.

In embodiments, guiding further movement of the trailer includes identifying one or more obstacles, and determining a probability of the one or more obstacles being in a path of movement of the trailer.

In embodiments, identifying one or more obstacles is performed with one or more additional sensors mounted to the vehicle.

In accordance with one or more illustrative embodiments, a method comprises mounting a sensor to a vehicle coupled to a trailer, obtaining, with the sensor, image data of an area beneath the trailer at one location, and determining, with the image data, one or more metrics of the trailer; wherein the method is performed at least in part by one or more processors coupled to memory.

In embodiments, the method further includes maneuvering the trailer with the vehicle based at least in part on the one or more metrics to at least a second location.

In embodiments, determining one or more metrics includes computing, utilizing the image data and a mathematical model, an angular relationship of the trailer relative to the vehicle.

In embodiments, the method includes obtaining, with the sensor, second image data of an area beneath the trailer at the at least a second location and determining, with the second image data, the one or more metrics of the trailer;

In embodiments, obtaining image data includes capturing with the sensor image data of a rear wheel of the trailer.

In embodiments, mounting a sensor includes coupling the sensor to the vehicle.

In embodiments, the method includes moving the sensor relative to the vehicle.

In embodiments, the method includes mounting the sensor to a sensor mount and wherein moving the sensor includes manipulating the sensor mount to selectively position the sensor at one or more vertical positions relative to the vehicle.

In embodiments, the sensor includes one of a LADAR sensor, LIDER sensor or a stereo camera.

### BRIEF DESCRIPTION OF THE DRAWINGS

The figures depict embodiments for purposes of illustration only. One skilled in the art will readily recognize from the following description that alternative embodiments of the systems and methods illustrated herein may be employed without departing from the principles described herein, wherein:

FIG. 1 is a block diagram of a system according to some embodiments;

FIG. 2 is a block diagram of a system according to some embodiments;

FIG. 3A and FIG. 3B are schematic views of a vehicle of a system according to some embodiments;

FIG. 4 and FIG. 5 are schematic views of a field of view and shadow regions of an imaging sensor of a system with the vehicle and the trailer in a parallel and angulated orientation to the according to some embodiments;

FIG. 6A and FIG. 6B are illustrations representative of an exemplary use of the system according to some embodiments.

FIG. 7 is a flow chart illustrating an exemplary method of use of a system according to some embodiments;

FIG. 8 is a block diagram of an apparatus according to some embodiments; and

FIG. 9A, FIG. 9B, FIG. 9C, FIG. 9D, and FIG. 9E are perspective diagrams of exemplary data storage devices according to some embodiments.

### DETAILED DESCRIPTION

### I. Introduction

It is not desirable for an autonomous vehicle to require a human operator/observer to be present during operations (i.e., it negates the autonomy of the vehicle) due to increased personnel and operational costs, and safety concerns. IT is also not desirable to rely upon or utilize trailer-mounted cameras, as trailers are often owned by various entities, e.g., other than a tractor or hosteler operator, and there is accordingly little control over what type of hardware a trailer may have pre-installed and/or there may be no permission to install such devices in situ. Accordingly, there is a need in the art for a solution that provides for rear-facing visibility that can permit an autonomous tractor, hosteller, and/or other autonomous vehicle to safely and effectively perform trailer backup maneuvers.

In some embodiments, systems, methods, and articles of manufacture for under-trailer sensing may be provided to overcome these and/or other deficiencies of previous systems and/or solutions. One or more sensors mounted to the rear and/or side of an autonomous vehicle may, for example, be oriented rearward and/or may be selectively deployable to capture data such as imagery and/or 3-D point cloud data descriptive of an area behind the autonomous vehicle. While many vehicles (autonomous or otherwise) typically utilize backup cameras, such cameras are ineffective for providing rearward visibility in the case of a trailer being oriented behind the vehicle. Accordingly, the under-trailer sensors contemplated herein are either fixed on the autonomous vehicle below the height of the body of the trailer or are selectively deployable to change the height of the sensor (e.g., above the ground surface). According to some embodiments, a rearward-facing sensor may be mounted at the rear of an autonomous vehicle on or via a height-adjustable track, slide, pole, and/or other mount such that the sensor may be raised away from the road surface, e.g., for driving so that the sensor does not become damaged due to ground and/or ground-obstacle contact, and/or deployed close to (e.g., within one to five inches (1-5″)) the road surface to obtain under-trailer visibility for trailer hitching, trailer stand placement, trailer backing, and/or other trailer-related maneuvering operations. In embodiments, the sensor is deployable or mounted beneath the vehicle. The sensor may be utilized, for example, to conduct and/or facilitate (i) trailer Advanced Driver Assistance Systems (ADAS) as described in co-pending Provisional Patent Application No. 63/343984 (Attorney Docket No. RR03-120-01) filed on May 19, 2022 and titled “SYSTEMS AND METHODS FOR YARD VEHICLE ADVANCED DRIVER ASSISTANCE SYSTEMS (ADAS)”, (ii) autonomous trailer stand deployment/management as described in co-pending Provisional Patent Application No. PCT/US23/24030 (Attorney Docket No. RR03-121-02) filed on May 31, 2023 and titled “SYSTEMS AND METHODS FOR AUTONOMOUS TRAILER STANDS”, and/or (iii) autonomous trailer stand deployment/management as described in co-pending PCT Patent Application Serial No. PCT/US23/34923 (Attorney Docket No. RR03-124-02) filed on Oct. 11, 2023 and titled “SYSTEMS AND METHODS FOR TRAILER MANEUVERING”.

### II. Under-Trailer Sensing/Maneuvering Systems

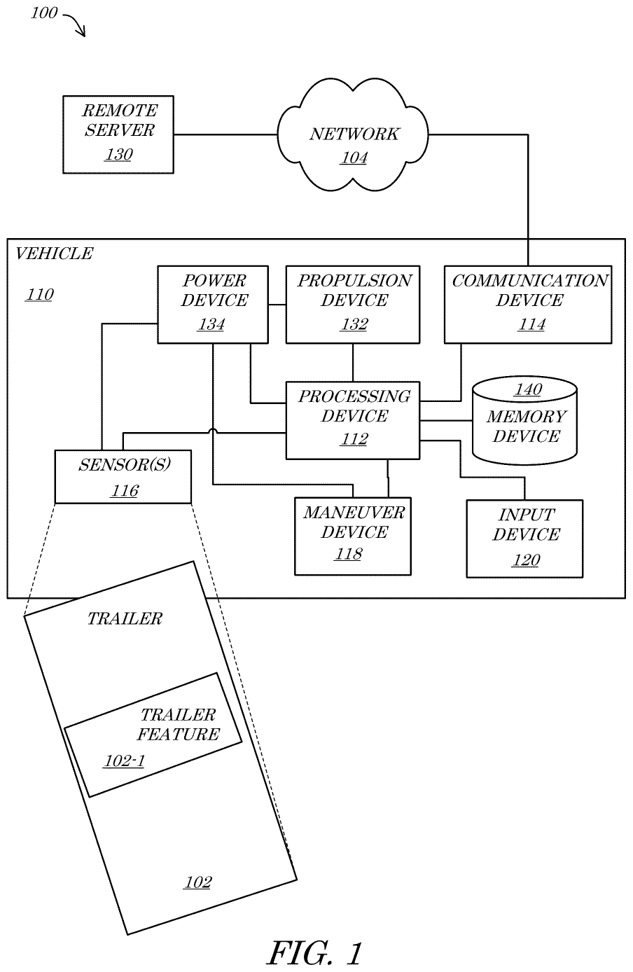

Referring first to FIG. 1, a block diagram of a system 100 according to some embodiments is shown. In some embodiments, the system 100 may comprise a trailer 102 (e.g., comprising a trailer feature 102-1), a network 104, and/or a vehicle 110. The vehicle 110 may comprise, for example, a processing device 112, a communication device 114, one or more sensor(s) 116, a maneuver device 118 and/or an input device 120. In some embodiments, the vehicle 110 may be in communication with, e.g., via the network 104, a remote server 130. According to some embodiments, the vehicle 110 may comprise a propulsion device 132, a power device 134, and/or a memory device 140.

Fewer or more components 102, 102-1, 104, 110, 112, 114, 116, 118, 120, 130, 132, 134, 140 and/or various configurations of the depicted components 102, 102-1, 104, 110, 112, 114, 116, 118, 120, 130, 132, 134, 140 may be included in the system 100 without deviating from the scope of embodiments described herein. In some embodiments, the components 102, 102-1, 104, 110, 112, 114, 116, 118, 120, 130, 132, 134, 140 may be similar in configuration and/or functionality to similarly named and/or numbered components as described herein. In some embodiments, the system 100 (and/or portion thereof) may comprise an under-trailer sensing and/or trailer maneuvering configuration and/or platform programmed and/or otherwise configured to execute, conduct, and/or facilitate one or more methods.

According to some embodiments, the trailer 102 may comprise any type, configuration, and/or quantity of trailers that are or become known or practicable. The trailer 102 may comprise, for example, a Great Dane® fifty-three-foot (53′) air-ride dry van trailer with rear swing doors available from Great Dane LLC of Chicago, IL or a Wabash National@ tandem high-spec refer trailer available from Wabash National Corporation of Lafayette, IN. In some embodiments, the trailer feature 102-1 may comprise various surfaces, doors, hinges, mounts, hitch points, lights, reflectors, etc. of the trailer 102. In some embodiments, the trailer feature 102-1 may comprise landing gear, a kingpin, a refrigeration (“refer”) unit, a side surface of the trailer 102, and/or a color, shape, graphic, machine-readable indicia, etc. thereof. The trailer 102 may, in some embodiments, comprise one (1), two (2), three (3), or fewer or more axles, wheels, junctions, pivots (e.g., articulation points), etc. In some embodiments, the trailer 102 may be selectively coupled or uncoupled from the vehicle 110.

The network 104 may, according to some embodiments, comprise a Local Area Network (LAN; wireless and/or wired), cellular telephone, Bluetooth®, Near Field Communication (NFC), and/or Radio Frequency (RF) network with communication links between the remote server 130 and the vehicle 110. In some embodiments, the network 104 may comprise direct communication links between any or all of the components 102, 102-1, 110, 112, 114, 116, 118, 120, 130, 132, 134, 140 of the system 100. The sensor 116 may, for example, be directly interfaced or connected to one or more of the processing device 112 and/or the remote server 130 via one or more wires, cables, wireless links, and/or other network components, such network components (e.g., communication links) comprising portions of the network 104. In some embodiments, the network 104 may comprise one or many other links or network components other than those depicted in FIG. 1. The vehicle 110 may, for example, be connected to the remote server 130 via various cell towers, routers, repeaters, ports, switches, and/or other network components that comprise the Internet and/or a cellular telephone (and/or Public Switched Telephone Network (PSTN) network, and which comprise portions of the network 104.

While the network 104 is depicted in FIG. 1 as a single object, the network 104 may comprise any number, type, and/or configuration of networks that is or becomes known or practicable. According to some embodiments, the network 104 may comprise a conglomeration of different sub-networks and/or network components interconnected, directly or indirectly, by the components 102, 102-1, 110, 112, 114, 116, 118, 120, 130, 132, 134, 140 of the system 100. The network 104 may comprise one or more cellular telephone networks with communication links between the communication device 114 and the remote server 130, for example, and/or may comprise an NFC or other short-range wireless communication path, with communication links between the vehicle 110 and the trailer feature 102-1, for example.

According to some embodiments, the vehicle 110 may comprise any type, configuration, and/or quantity of vehicle, manned, unmanned, autonomous, or semi-autonomous, that is or becomes known or practicable. The vehicle 110 may comprise, for example, an autonomous path-following transportation vehicle that is operable to follow one or more predefined and/or automatically computed paths through a yard and/or other area (not shown) or a manned vehicle 110 that comprises the sensor 116 that facilitates safe traversal of the manned vehicle 110 through the yard/area. In some embodiments, the vehicle 110 may comprise the processing device 112 such as a Central Processing Unit (CPU) that executes instructions (not shown) stored in the memory device 140 to operate in accordance with embodiments described herein. The processing device 112 may, for example, execute one or more programs, modules, and/or routines that facilitate utilization of the sensor 116 and/or the communication device 114 to facilitate safe maneuvering of the vehicle 110 through the yard/area, e.g., as it transports, parks, and/or retrieves the trailer 102. The processing device 112 may comprise, in some embodiments, one or more Eight-Core Intel® Xeon® 7500 Series electronic processing devices.

According to some embodiments, the communication device 114 may comprise any wired and/or wireless communication object and/or network device such as, but not limited to, a Radio Frequency (RF) antenna, transmitter, and/or receiver. In some embodiments, the communication device 114 may comprise hardware, software, and/or firmware operable to enable wireless communications including, but not limited to, encoding and/or decoding modules, filters, and/or encryption and/or decryption modules. In some embodiments, the communication device 114 may comprise one or more output devices such as buzzers, lights, alarms, vibration devices, etc. The communication device 114 may comprise, for example, an ADAS output device that provides ADAS output to a driver of the vehicle 110.

According to some embodiments, the input device 120 may comprise one or more of a throttle, a steering, and a brake control mechanism and/or interface via which a human operator may control the speed and/or direction of the vehicle 110 (and, e.g., the coupled trailer 102). The operator may, for example, utilize the input device 120 to define a control action to decide the speed of the vehicle 110 as well as to make decisions such as when to stop or to continue past, around, over, and/or under (e.g., to mate with or to clear/avoid) the trailer feature 102-1. According to some embodiments, the input device 120 may comprise one or more switches, levers, wheels, pedals, and/or interface elements capable of communicating speed, direction, etc.

In some embodiments, the input device 120 may comprise any type, quantity, and/or configuration of location identification and/or tracking device that is or becomes known or practicable. The input device 120 may comprise a location device, for example, such as one or more Global Positioning System (GPS) devices, wireless signal triangulation devices, atomic clocks, etc.

According to some embodiments, the sensor 116 may comprise any type, configuration, and/or quantity of sensor devices that are or become known or practicable. In some embodiments, the one or more sensors 116 may comprise a Light Detection and Ranging (LiDAR), LAser Detection and Ranging (LADAR), radar, sonar, Infrared Radiation (IR), RF, ultrasound, structured light, and/or imaging (e.g., stereo vision and/or 3-D camera) device operable to acquire data descriptive of the trailer 102 and/or the trailer feature 102-1 (e.g., tires, rear tires, hitch points, side surfaces, etc.) thereof. The one or more sensors 116 may be mounted to the vehicle 110 and/or the trailer 102. According to some embodiments, the one or more sensors 116 may also or alternatively comprise a gyroscope, image, audio, and/or video capture and/or recording device, chemical detection device, and/or a light sensor. According to some embodiments, the one or more sensors 116 may comprise various movement sensors such as speed/velocity sensors, pressure sensors, temperature sensors, accelerometers, Inertial Measurement Unit (IMU) devices, and/or tilt sensors. In some embodiments, the one or more sensors 116 may comprise one or more sensing units coupled and/or oriented in a rearward fashion to capture image data descriptive of an area behind the vehicle 110 and/or behind the trailer 102. According to some embodiments, a given sensor 116 of the one or more sensors 116 may be selectively deployable and/or be height-adjustable such that the sensor 116 may be selectively deployed and/or oriented underneath a body and/or deck (e.g., and/or other trailer feature 102-1) of the trailer 102.

In some embodiments, the maneuver device 118 may comprise any type, quantity, and/or configuration of mechanical, electrical, and/or electro-mechanical devices that are operable to control the path of the vehicle 110 (and/or trailer 102). The maneuver device 118 may comprise, for example, steering linkage, actuators, control surfaces, thrust vectoring devices, etc. In some embodiments, the maneuver device 118 may be coupled to and/or in communication with the propulsion device 132. The maneuver device 118 may comprise, for example, a steer-by-wire system that permits computerized control of the maneuvering of the vehicle 110 and/or the trailer 102. The maneuver device 118 and the propulsion device 132 may, for example, operate in a coordinated fashion (e.g., in response to commands from the processing deice 112) to cause the vehicle 110 and/or the trailer 102 to follow a desired path and/or route through the yard/area.

According to some embodiments, the propulsion device 132 may comprise any type, configuration, and/or quantity of propulsion devices that are operable to move the vehicle 110 and/or the trailer 102 from one location to another. The propulsion device 132 may comprise, for example, one or more motors, engines, gears, drives, propellers, fans, jets, nozzles, wheels, treads, and/or magnetic propulsion devices. According to some embodiments, the power device 134 may be electrically, mechanically, and/or fluidly coupled to provide power to any or all of the propulsion device(s) 132, the communication device 114, the processing device 112, the input device 120, the sensor 116, and/or the maneuver device 118. In some embodiments, the power device 134 may comprise a power source such as a solar panel, inertial generator, on-board generator, alternator, fuel-cell, external power supply port, etc. According to some embodiments, the power device 134 may also or alternatively comprise a power storage device such as one or more capacitors, batteries, fuel reservoirs or tanks, etc.

In some embodiments, the memory device 140 may store various logic, code, and/or applications, each of which may, when executed, participate in, facilitate, and/or cause automatic trailer maneuvering, as described herein. In some embodiments, the memory device 140 may comprise any type, configuration, and/or quantity of data storage devices that are or become known or practicable. The memory device 140 may, for example, comprise an array of optical and/or solid-state memory cards or hard drives configured to store sensor data, maneuvering data (e.g., formulas, models, rules, etc.), object classification data, navigation data, road network data, rules of the road data, routing data (e.g., analysis formulas and/or mathematical models), credentialing and/or communication instructions, codes, and/or keys, and/or various operating instructions, drivers, etc. In some embodiments, the memory device 140 may comprise a solid-state and/or non-volatile memory card (e.g., a Secure Digital (SD) card, such as an SD Standard-Capacity (SDSC), an SD High-Capacity (SDHC), and/or an SD extended-Capacity (SDXC) and any various practicable form-factors, such as original, mini, and micro sizes, such as are available from Western Digital Corporation of San Jose, CA. While the memory device 140 is depicted as a stand-alone component of the vehicle 110, the memory device 140 may comprise multiple components. In some embodiments, a multi-component memory device 140 may be distributed across various devices and/or may comprise remotely dispersed components. Any of the vehicle 110, the trailer 102, and/or the remote server 130 may comprise the memory device 140 or a portion thereof, for example.

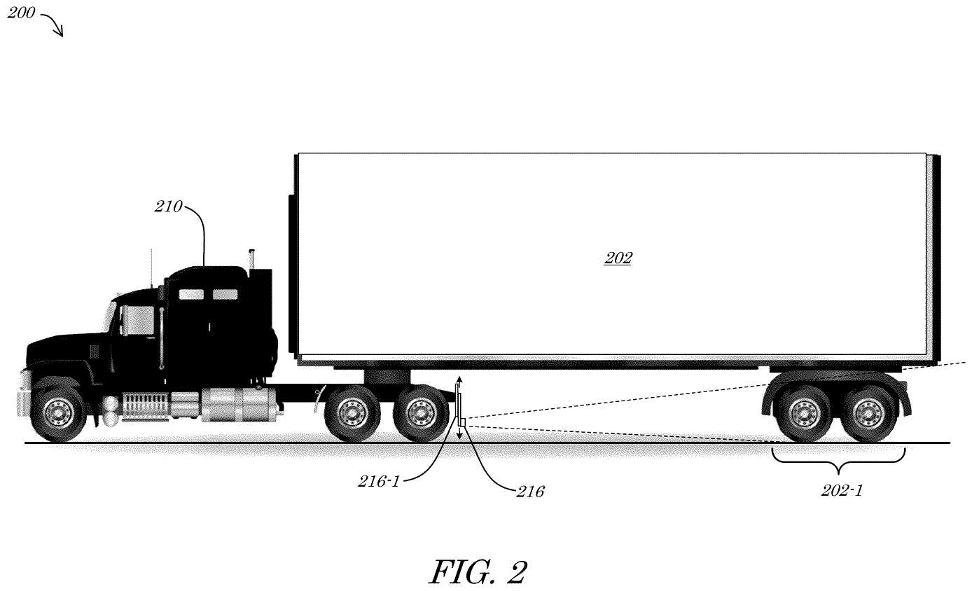

Turning to FIG. 2, a block diagram of a system 200 according to some embodiments is shown. In some embodiments, the system 200 may be similar in configuration and/or functionality to the system 100 of FIG. 1 herein. The system 200 may, for example, comprise a trailer 202 (defining one or more trailer features 202-1 such as the rear axles, rear wheels, and/or tires, as depicted) coupled to a vehicle 210 (e.g., the tractor/rig as depicted). In some embodiments, the vehicle 210 may comprise one or more sensors such as one or more LADARS, cameras 216, e.g., coupled to (and/or proximate to) the rear end (not separately labeled) of the vehicle 210. According to some embodiments, the sensor(s) 216 may be oriented to comprise a Field of View (FoV) that encompasses an area underneath and behind the trailer 202 (e.g., the FoV being generally depicted by dotted lines in FIG. 2). The field of view may extend up to areas inclusive of 180 degrees or less. According to some embodiments, the sensor 216 may record, identify, and/or locate the trailer feature 202-1. In some embodiments the system 200 may utilize the sensor 216 to identify the trailer feature 202-1 and various attributes thereof (e.g., at a first time) such as wheels, including rear wheels, colors, shapes, graphics, indicia, and/or geometric attributes such as axles, suspension components, etc. (none of which are separately labeled).

According to some embodiments, the attributes and/or characteristics of the trailer feature 202-1 may be utilized by the system 200 to compute an angle, position, orientation, and/or attribute of the trailer 202. Data captured by the camera/sensor 216 may be utilized, for example, to output data, messages, and/or warnings to an operator of the vehicle 210 (e.g., in the case there is one) and/or to automatically control and/or direct the maneuvering of the vehicle 210 and trailer 202, e.g., to align with a loading dock (not shown).

In some embodiments, the sensor 216 may be selectively adjusted via an adjustable mount 216-1 that is operable to move the sensor vertically (and/or horizontally) to adjust the FOV to capture data descriptive of underneath and/or behind the trailer 202. The adjustable mount 216-1 may be automatically and/or electronically controlled and/or positioned, for example, such that the sensor 216 is selectively lowered and/or raised based on driving conditions and/or modes of the vehicle 210. In the case that the vehicle 210 is driving forward, for example, the adjustable mount 216-1 may be raised to move the camera/sensor 216 away from the road surface (e.g., to avoid damage and/or to increase ground clearance of the vehicle 210). In the case that the vehicle 210 is in reverse, e.g., to couple to the trailer 202 and/or the back the trailer 202, the adjustable mount 216-1 may be lowered to deploy the camera/sensor 216 such that it is oriented to capture data from underneath of the trailer 202. In some embodiments, the deployment of the camera/sensor 216 and/or adjustment and/or setting of the adjustable mount 216-1 may be set based on data descriptive of the surrounding environment. Upon engagement of reverse (and/or a trailer coupling and/or towing mode), for example, a distance between (i) the camera/sensor 216, (ii) the ground/road surface, and/or (iii) the trailer feature(s) 202-1, may be sensed and/or computed. The adjustable mount 216-1 may then be adjusted (e.g., automatically and/or autonomously) to position the camera/sensor 216 above the ground surface (e.g., within a minimum threshold clearance distance to avoid damage, such as one inch (1″) above the ground) and below one or more trailer features 202-1 such as the main body of the trailer 202. The distance and/or clearance may be measured, in some embodiments, by the camera/sensor 216 itself and/or be another sensor (not shown). According to some embodiments, the adjustable mount 216-1 may comprise a ground-engaging end-element (not shown) such as a wheel or roller that tracks the ground surface by rolling along the ground as the vehicle 210 moves backward. In such a manner, in the case that the camera/sensor 216 is mounted at a fixed distance above the end-element, the camera/sensor 216 may be automatically maintained at a default and/or minimum threshold distance above the ground surface. In some embodiments, the camera/sensor 216 may be move upward (and/or laterally) to avoid detected objects on and/or variations in the ground surface (e.g., to avoid damage).

According to some embodiments, data from the camera/sensor 216 may be utilized by the system 200 employing a Machine Learning (ML) and/or Artificial Intelligence (AI) model to identify, classify, and/or locate the trailer feature(s) 202-1 at different times, orientations, and/or locations. The ML/AI model may be trained to learn the trailer feature(s) 202-1, for example, such as at different trailer angles and/or orientations. In some embodiments, the ML/AI model may be utilized to predict and/or emulate visual view data for the area behind the trailer 202 that is currently blocked by the trailer feature(s) 202-1. The system 200 may utilize data from the camera/sensor 216 taken at a first time, for example, to fill-in and/or interpret gaps in data from a current time in which a portion of the rearward FOV is blocked by the trailer feature(s) 202-1.

Fewer or more components 202, 202-1, 210, 260a-b, 262a-b, 269A-b, 266 and/or various configurations of the depicted components 202, 202-1, 210, 260a-b, 262a-b, 269A-b, 266 may be included in the system 200 without deviating from the scope of embodiments described herein. In some embodiments, the components 202, 202-1, 210, 260a-b, 262a-b, 269A-b, 266 may be similar in configuration and/or functionality to similarly named and/or numbered components as described herein. In some embodiments, the system 200 (and/or portion thereof) may comprise an under-trailer sensing and/or trailer maneuvering configuration and/or platform programmed and/or otherwise configured to execute, conduct, and/or facilitate one or more methods.

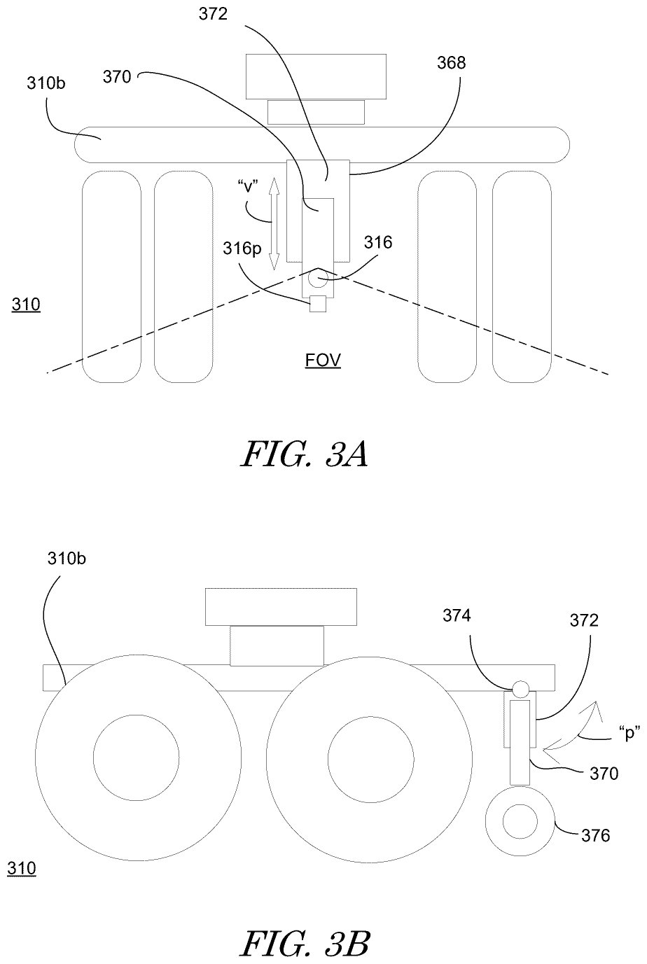

FIG. 3A is a rear schematic view of one illustrative embodiment of a vehicle 310. The vehicle 310 includes a sensor mount 368 having, in embodiments, an inner member 370 telescopically received within an outer member 372, and a sensor 316 mounted to the inner member 370. The inner member 370 may reciprocally move in the vertical direction (directional arrows “v”) within the outer member 372 to position the sensor 316 at a desired vertical location relative to the bed 310b of the vehicle 310 and the ground. In embodiments, the sensor 316 is a LADAR sensor providing a field of view “FOV” (defined within the dashed lines) extending beneath and toward the rear of the vehicle 310 and the trailer (not shown). In other embodiments, the sensor 316 may include a stereo camera device. The sensor mount 368 may also include a supplemental position sensor 316p configured to detect the position of the inner member 370 relative to the ground to enable selective control/movement of the inner member 370, which thereby permits selective control of the location of the sensor 316 relative to the trailer and/or the ground. Any suitable position sensor, transducer, camera may be utilized. The inner member 370 may selectively move via control of the processing device 112 based on feedback data gathered by the position sensor 316p. In embodiments, the inner member 370 may be fully retracted within the outer member 372 during movement of the vehicle about, for example, the yard, to avoid engagement of the sensor mount 368 within the ground.

FIG. 3B is a side schematic view of one illustrative embodiment of a sensor mount 369A coupled to the vehicle 310. The sensor mount 369A is pivotally mounted to the bed 310b via a pivot pin or linkage 374 and is configured to transition or pivot along directional arrow “p” between an active state depicted in FIG. 3B and a transit state (not shown) in which the sensor mount 369A is flush or parallel with the vehicle bed 310b. The sensor mount 369A may further include a wheel 376 to engage the ground during, for example, backing maneuvers. A sensor 516 (not specifically shown) is mounted to the inner member 370.

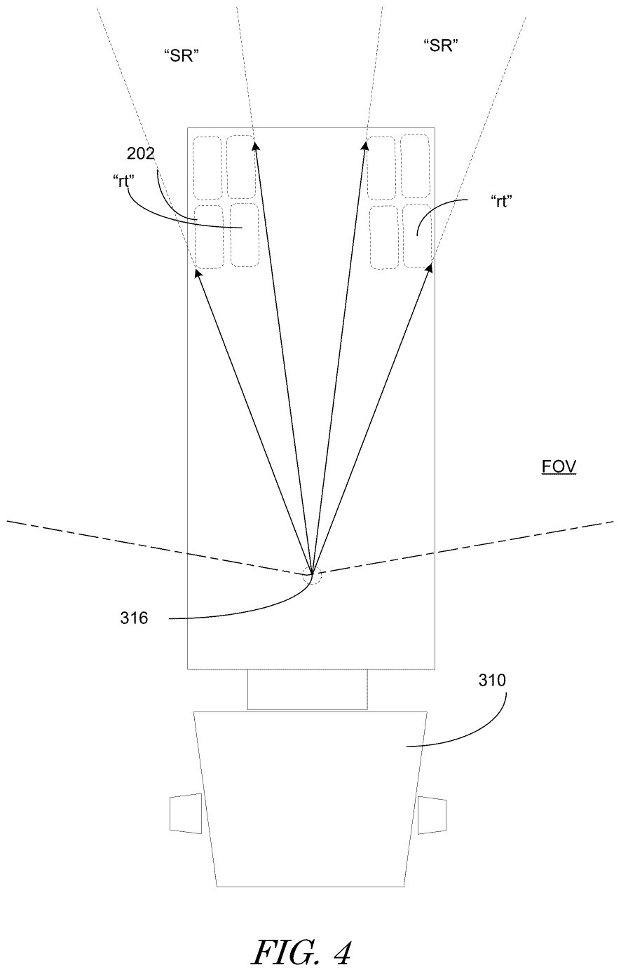

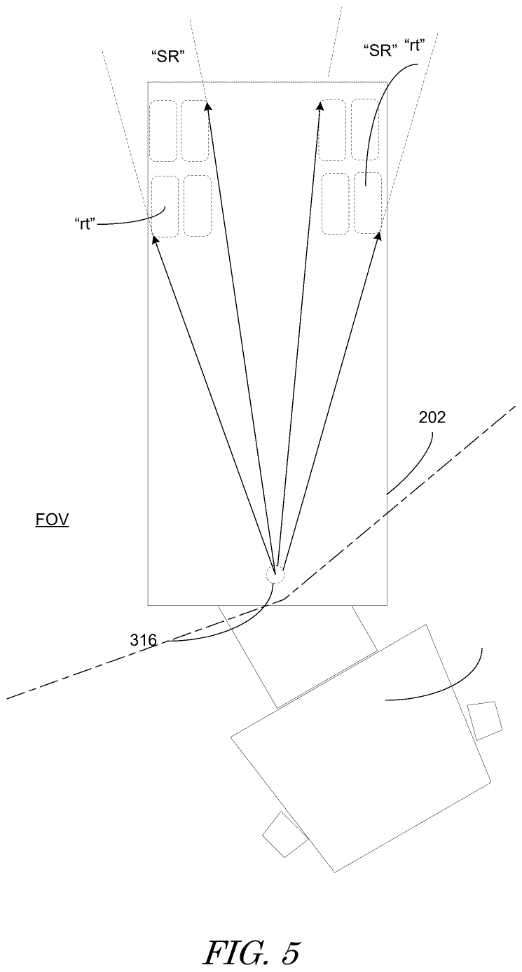

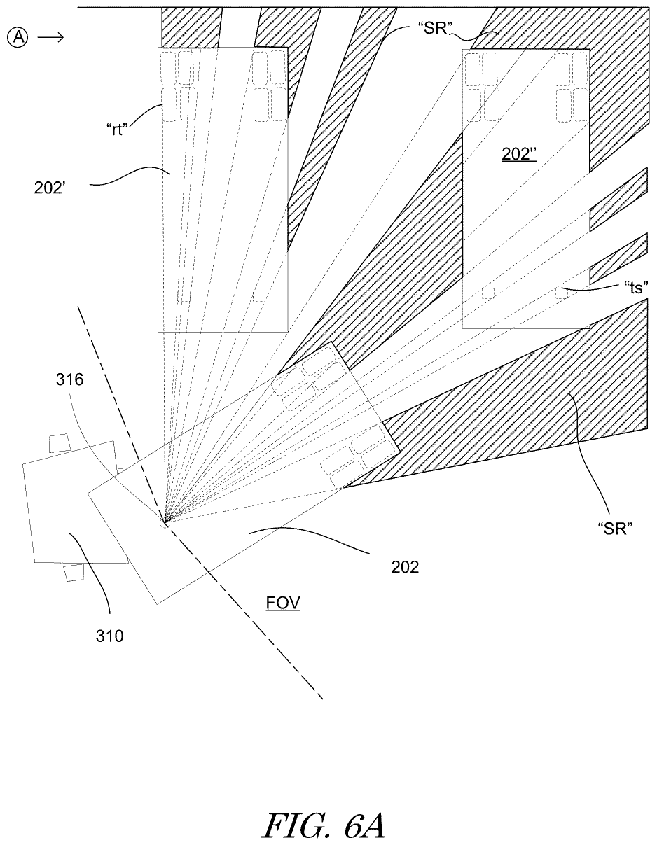

FIG. 4 is a schematic illustrating a field of view of an area scanned by the sensor 316 of the sensor mounts 368, 369A of FIGS. 3A and 3B. In embodiments, the sensor 316 is a LADAR sensor positioned beneath the vehicle 310 and arranged to capture data such as imagery and/or 3-D point cloud data descriptive of an area beneath and behind the autonomous vehicle 310 and the trailer 202. For example, the sensor 316 may have a Field of View depicted as “FOV.” However, within the FOV is one or more shadow areas or regions “SR” due to the presence and intersection of the rear tires “RT”, within the FOV. These shadow regions “SR” may be in the shape of a frustum within the 3D point cloud data in which visibility behind the rear tires of the trailer is inhibited, restricted and/or not possible. The shadow regions “SR” may be, in effect, blind spots in the FOV where obstacles, humans, other trailers, etc. may not be properly detected. Thus, an object within or entering the area confined by the shadow regions “SR” (within the edges of the shadow regions “SR”) behind the trailer 202 may be at risk of engagement by the trailer during a backing maneuver. In FIG. 4, the vehicle 310 and the trailer 202 are in alignment (0 degrees) relative to each other. The frustum shadow regions “SR” are also in alignment with the vehicle 310 and the trailer 202.

FIG. 5 is a schematic view illustrating the vehicle 310 during a maneuvering procedure (for example, during backing up of the trailer 202) in which the vehicle 310 is arranged offset at an angle relative to the trailer 202. During the backing up procedure with the vehicle angulated relative to the trailer 202, the shadow regions SR are different and located in a different location relative to the trailer 202 and within the 3D point cloud data captured within the FOV of the sensor 316. In embodiments, the differences in locations of the shadow regions SR may assist in determining one or more metrics/attributes (including angle, orientation of the trailer 202 relative to the vehicle 310) associated with the trailer 202 which may assist in maneuvering the trailer 202 about the yard site. In some embodiments, visual data obtained by sensor 316 of sensor mount 368, 369A obtained when the vehicle 310 and trailer 202 are in the position of FIG. 4 is used to supplement any missing visual data within the shadow regions SR created by the rear tires when in the orientation of FIG. 5. Similarly, or alternatively, any visual data obtained by sensor 316 of sensor mount 368, 369A obtained when the vehicle 310 and trailer 202 are in the position of FIG. 5 may be used to supplement any missing visual data within the shadow regions SR created by the rear tires when in the orientation of FIG. 4. As a further option, any of the other sensors 116 described hereinabove (for example, cameras mounted to the mirrors of the vehicle 310, etc.) in connection with FIG. 1 may be utilized to capture visual data of the area and/or attributes of the trailer and the vehicle to supplement the data obtained by sensor 316.

In embodiments, the angular orientation of the trailer 202 relative to the vehicle 310 may be calculated. For example, the location of any one of the rear tires “rt” may be readily detected with the image sensor 316. This trailer feature, for example, the rear tires “rt” may be utilized by the system 200 to determine the angle “a” of the trailer 202 relative to the vehicle 210 at one or more time instances, i.e., when the vehicle 210 and trailer 202 have been maneuvered from one position and/or orientation to another position and/or orientation depicted in FIG. 5. The information used to calculate the angular orientation may include the know characteristics of the FOV, data obtained by additional sensors on the vehicle and/or trailer, etc.

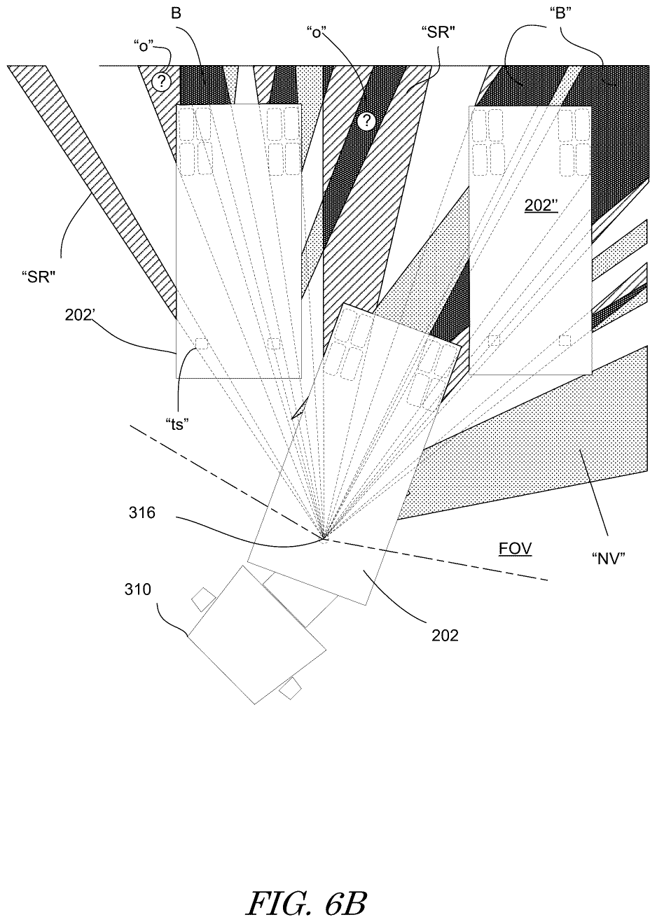

FIGS. 6A and 6B are illustrations representative of an exemplary use of the system according to some embodiments. In FIG. 6A, the vehicle 310 is coupled to the trailer 202 via the hitch and is in the process of moving in a rearward or backward direction to park the trailer 202 between two previously parked trailers 202′, 202″. The sensor 316 provides a FOV approaching, for example, 180 degrees. The open area between the dashed lines “--” represent visible areas in which the sensor provides visibility beneath the trailer 202 and beyond the rear of the trailer is available. The areas represented by the diagonal cross-hatches represent shadow regions “SR” is obtained where visibility of the sensor 316 is blocked by for example, the rear tires or wheels of the trailer 202 and/or the trailer stands “ts”. The data inclusive of the open areas and the shadow regions “SR” is collected and stored in memory associated with the processor. In FIG. 6A, an object such as a person “A” is depicted approaching the FOV.

Inn FIG. 6B, the vehicle 310 continues backing the trailer 202 into the space between the trailers 202′, 202″. As the vehicle 312 moves/rotates or angulates, the sensor 316 moves accordingly altering the FoV. The areas identified by the diagonal lines “SR” are shadow regions caused by the various obstacles associated with the trailers 202, 202′, 202′ including the rear tires “rt” and the trailer stands “ts” similar to FIG. 6A. The dotted area(s) identified by the indicator “NV” represent areas behind various obstacles which were previously within a shadow region SR when the vehicle 310 and the sensor 316 were in the position of FIG. 6A but are now visible. The areas identified in dark or black shading designated as “B” are areas that are not visible by the sensor 316 in either the position of the vehicle 310 and the trailer 202 of FIGS. 6A and 6B. These areas are essentially blind spots. The data inclusive of the open areas, the shadow regions “SR2” and the blocked area “b” is collected and stored in memory associated with the processor. In FIG. 6B, objects “o” such as a person or any other obstacle is shown in various regions of the FoV.

FIG. 6 is a flow chart 480 illustrating one exemplative method of use of the system of FIGS. 1-5. In embodiments, the system is an automated trailer maneuvering system of the type(s) described hereinabove including a trailer, a hitch coupled to the trailer and a vehicle coupled to the hitch. The vehicle 310 includes an image sensor 316 (for example, a LaDAR sensor) coupled to have a field of view oriented to encompass an area underneath and/or beyond the trailer. The method may commence with STEP 482 in which the sensor 316 receives, at a first time, first image data of the area underneath of the trailer 202. The first image data may include 3D point cloud data collected by the sensor when, for example, the trailer 202 and the parallel orientation of FIG. 5 or the first angulated position of FIG. 6A. The 3D point cloud data may include the shadow regions “SR” and also may include data of one or more other obstacles within the FOV. In STEP 484, a first value for one or more metrics of the trailer 202 is computed utilizing the first image data and a mathematical model. The one or more metrics or attributes may be, for example, angle, position, and/or length of the trailer. In embodiments, the first metric may be the angle of orientation of the trailer 202 relative to the vehicle 310. The trailer 202 is moved by actuation of the vehicle 310 in combination, for example, with a turn of the vehicle. Movement may be forward and/or rearward. (STEP 486). In STEP 488, second image data of the area underneath of the trailer 202 is received from the sensor and at a second time. In embodiments, for example, the second image data may include 3D point cloud data collected by the sensor when, for example, the trailer 202 and the vehicle 310 are angulated or pivoted relative to each other as shown in FIG. 6A or FIG. 6B. The 3D point cloud data may include the shadow regions “SR” and also may include data of one or more other obstacles within the FOV. In STEP 490, a second value for the one or more metrics of the trailer 202 is computed utilizing the second image data and the mathematical model. In STEP 492, a difference between the first and second values for the one or more metrics of the trailer is computed. As an option, in STEP 494, the first and second image data may be analyzed to determine if any additional obstacles are present in the image data. In the event one or more additional unexpected obstacles are present, a determination may be made to the probability the one or more obstacles will enter or impede a path of the vehicle and the trailer. The one or more obstacles may be another trailer, human personnel, equipment etc. The determination may be based on the expected time of travel of the obstacle from the location identified in the image data to a proposed path of the trailer. Various algorithms may be utilized to make this determination a Monte Carlo method or algorithm or any other suitable algorithm. In some embodiments, the one or more obstacles may be detected by other sensors 116 associated with the vehicle including other mounted cameras, LIDARS, etc. of the type described in connection with FIG. 1. The method may be completed by guiding, based on the computed difference between the first and second values of the one or more metrics of the trailer (and obstacles if present) further movement of the trailer (for example, rearward movement). (STEP 496) In embodiments, if a detected obstacle in STEP 494 is concerning the guidance may be terminated until remedial action is taken. One or more steps of the method are performed by an electronic processing device, and a memory storing instructions to perform the one or more steps.

In embodiments, the image data collected by the sensor 316 in the positions of FIGS. 4-6B including obstacle data etc. is processed, and incorporated into the software instructions to guide the vehicle 316 and the trailer 202 along a path within the site, for example, between the parked trailers 202′, 202″ as depicted in FIGS. 6A and 6B. In embodiments, the obstacles are mobile such as a human and/or a vehicle. Movement of the mobile obstacles may also be tracked. In embodiments, the probability (e.g., speed and time based) of the mobile objects moving to within shadow regions “SR” or totally blocked regions may be calculated. Activity of the vehicle may be terminated in the event the probability of a mobile object reaches a predetermined value.

### III. Under-Trailer Sensing/Maneuvering Apparatus & Articles Of Manufacture

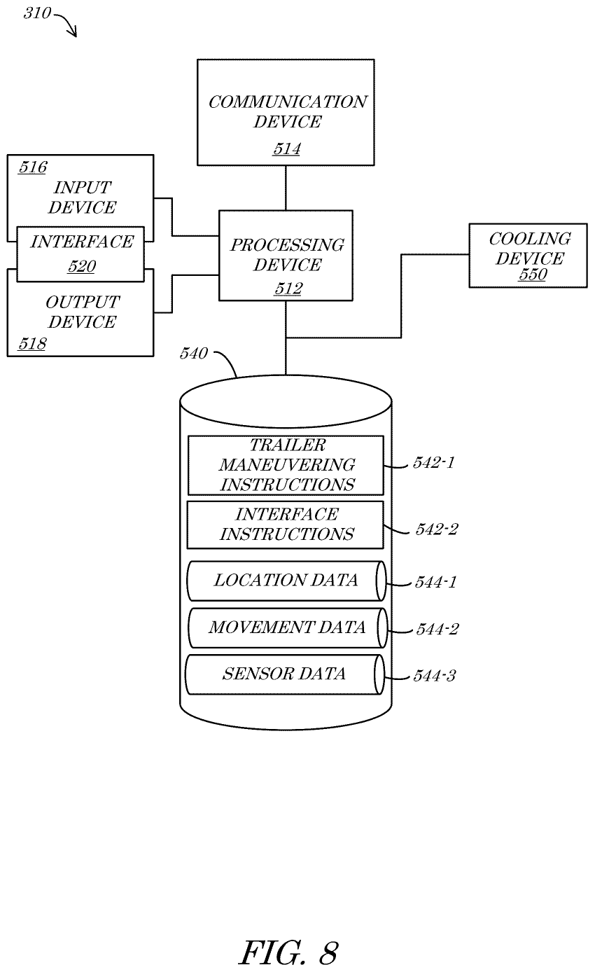

Turning to FIG. 8, a block diagram of an apparatus 510 according to some embodiments is shown. In some embodiments, the apparatus 510 may be similar in configuration and/or functionality to one or more of the vehicle 110, 210, 310 of FIGS. 1 to 6 herein. The apparatus 510 may, for example, execute, process, facilitate, and/or otherwise be associated with a method in which an under-trailer sensing and/or trailer maneuvering configuration and/or platform is utilized to conduct and/or facilitate trailer backing maneuvers. In some embodiments, the apparatus 510 may comprise a processing device 512, a communication device 514, an input device 516, an output device 518, an interface 520, a memory device 540 (storing various programs and/or instructions 542 and data 544), and/or a cooling device 530. According to some embodiments, any or all of the components 512, 514, 516, 518, 520, 540, 542, 544, 530 of the apparatus 510 may be similar in configuration and/or functionality to any similarly named and/or numbered components described herein. Fewer or more components 512, 514, 516, 518, 520, 540, 542, 544, 530 and/or various configurations of the components 512, 514, 516, 518, 520, 540, 542, 544, 530 may be included in the apparatus 510 without deviating from the scope of embodiments described herein.

According to some embodiments, the processor 512 may be or include any type, quantity, and/or configuration of processor that is or becomes known. The processor 512 may comprise, for example, an Intel® IXP 2800 network processor or an Intel® XEON™ Processor coupled with an Intel® E7301 chipset. In some embodiments, the processor 512 may comprise multiple inter-connected processors, microprocessors, and/or micro-engines. According to some embodiments, the processor 512 (and/or the apparatus 510 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 510 comprises a server, such as a blade server, necessary power may be supplied via a standard AC outlet, power strip, surge protector, and/or Uninterruptible Power Supply (UPS) device.

In some embodiments, the communication device 514 may comprise any type or configuration of communication device that is or becomes known or practicable. The communication device 514 may, for example, comprise a Network Interface Card (NIC), a telephonic device, a cellular network device, a router, a hub, a modem, and/or a communications port or cable. In some embodiments, the communication device 514 may be coupled to receive location data, e.g., from a sensor device (not separately shown in FIG. 3). The communication device 514 may, for example, comprise a BLE and/or RF receiver device and/or a camera or other imaging device that acquires data descriptive of a location and/or a transmitter device that provides the data to a remote server and/or server or communications layer. According to some embodiments, the communication device 514 may also or alternatively be coupled to the processor 512. In some embodiments, the communication device 514 may comprise an IR, RF, Bluetooth™, Near-Field Communication (NFC), and/or Wi-Fi® network device coupled to facilitate communications between the processor 512 and another device (such as a remote user device, e.g., a tele-operations station.

In some embodiments, the input device 516 and/or the output device 518 are communicatively coupled to the processor 512 (e.g., via wired and/or wireless connections and/or pathways) and they may generally comprise any types or configurations of input and output components and/or devices that are or become known, respectively. The input device 516 may comprise, for example, a knob, wheel, lever, shifter, pedal, button, switch, and/or other object that permits an operator (e.g., local or remote operator personnel) to control a speed and/or direction of the apparatus 510. In some embodiments, the input device 516 may comprise a sensor, such as a camera, sound, light, radar, RF, and/or proximity sensor, configured to measure and/or record values via signals to the apparatus 510 and/or the processor 512. The output device 518 may, according to some embodiments, comprise a display screen and/or other practicable output component and/or device such as a sounder, light, vibration device, etc. The output device 518 may, for example, provide an interface (such as the interface 520) via which ADAS safety, warning, rules, and/or navigation data may be provided to a vehicle operator (e.g., via a mobile device application). According to some embodiments, the input device 516 and/or the output device 518 may comprise and/or be embodied in a single device, such as a touch-screen monitor.

The memory device 540 may comprise any appropriate information storage device that is or becomes known or available, including, but not limited to, units and/or combinations of magnetic storage devices (e.g., a hard disk drive), optical storage devices, and/or semiconductor memory devices such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 540 may, according to some embodiments, store one or more of trailer maneuvering instructions 542-1 and/or interface instructions 542-2, location data 544-1, movement data 544-2, and/or sensor data 544-3. In some embodiments, the trailer maneuvering instructions 542-1 and/or interface instructions 542-2, location data 544-1, movement data 544-2, and/or sensor data 544-3 may be utilized by the processor 512 to provide output information via the output device 518 and/or the communication device 514.

According to some embodiments, the trailer maneuvering instructions 542-1 may be operable to cause the processor 512 to process the location data 544-1, movement data 544-2, and/or sensor data 544-3 in accordance with embodiments as described herein. Location data 544-1, movement data 544-2, and/or sensor data 544-3 received via the input device 516 and/or the communication device 514 may, for example, be analyzed, sorted, filtered, decoded, decompressed, ranked, scored, plotted, and/or otherwise processed by the processor 512 in accordance with the trailer maneuvering instructions 542-1. In some embodiments, location data 544-1, movement data 544-2, and/or sensor data 544-3 may be fed by the processor 512 through one or more mathematical and/or statistical formulas and/or models in accordance with the trailer maneuvering instructions 542-1 to automatically compute trailer metrics such as angle, position, and/or length and provide instructions, alerts, guidance, and to automatically maneuver a trailer, e.g., based on data from an automatically height-adjusted rear-facing sensor, as described herein.

In some embodiments, the interface instructions 542-2 may be operable to cause the processor 512 to process the location data 544-1, movement data 544-2, and/or sensor data 544-3 in accordance with embodiments as described herein. Location data 544-1, movement data 544-2, and/or sensor data 544-3 received via the input device 516 and/or the communication device 514 may, for example, be analyzed, sorted, filtered, decoded, decompressed, ranked, scored, plotted, and/or otherwise processed by the processor 512 in accordance with the interface instructions 542-2. In some embodiments, location data 544-1, movement data 544-2, and/or sensor data 544-3 may be fed by the processor 512 through one or more mathematical and/or statistical formulas and/or models in accordance with the interface instructions 542-2 to provide ADAS trailer maneuver warnings and/or data, e.g., under and/or rear trailer views/images, to the operator, as described herein.

According to some embodiments, the apparatus 510 may comprise the cooling device 530. According to some embodiments, the cooling device 530 may be coupled (physically, thermally, and/or electrically) to the processor 512 and/or to the memory device 540. The cooling device 530 may, for example, comprise a fan, heat sink, heat pipe, radiator, cold plate, and/or other cooling component or device or combinations thereof, configured to remove heat from portions or components of the apparatus 510.

Any or all of the exemplary instructions and data types described herein and other practicable types of data may be stored in any number, type, and/or configuration of memory devices that is or becomes known. The memory device 540 may, for example, comprise one or more data tables or files, databases, table spaces, registers, and/or other storage structures. In some embodiments, multiple databases and/or storage structures (and/or multiple memory devices 540) may be utilized to store information associated with the apparatus 510. According to some embodiments, the memory device 540 may be incorporated into and/or otherwise coupled to the apparatus 510 (e.g., as shown) or may simply be accessible to the apparatus 510 (e.g., externally located and/or situated).

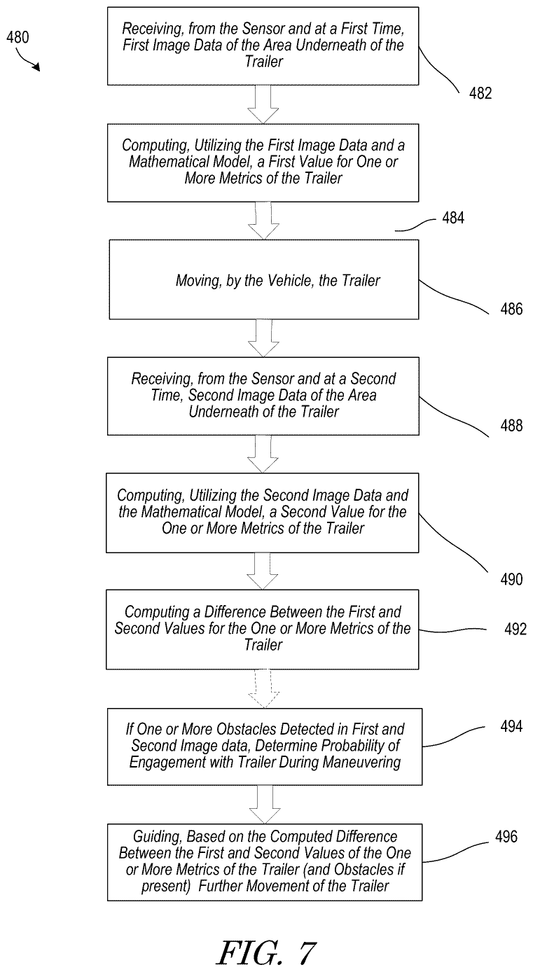

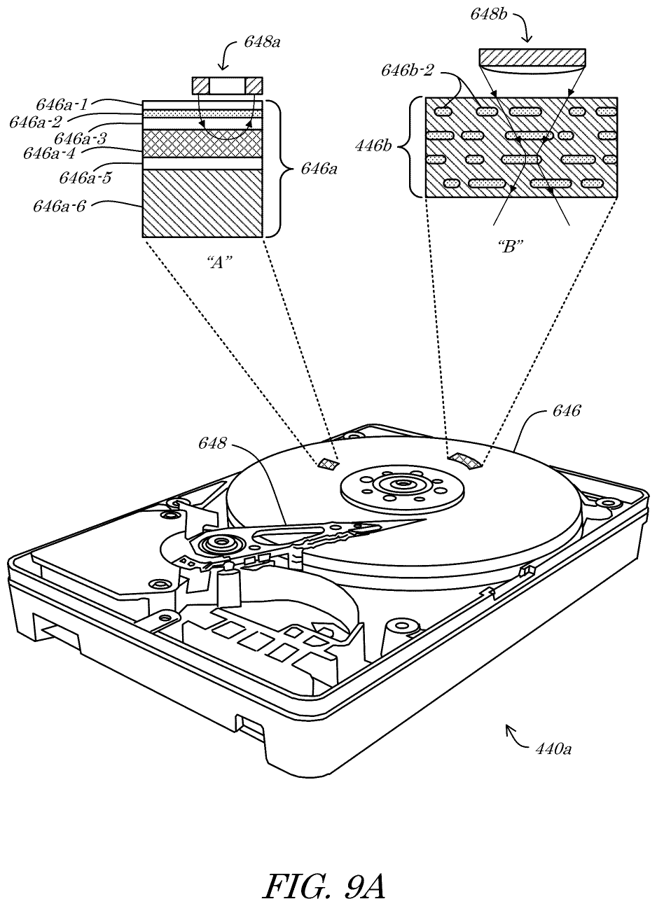

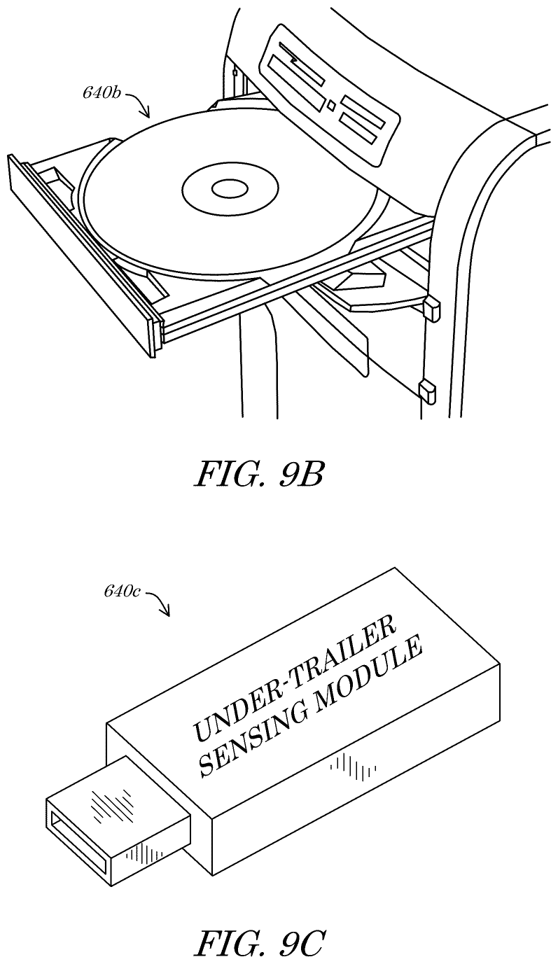

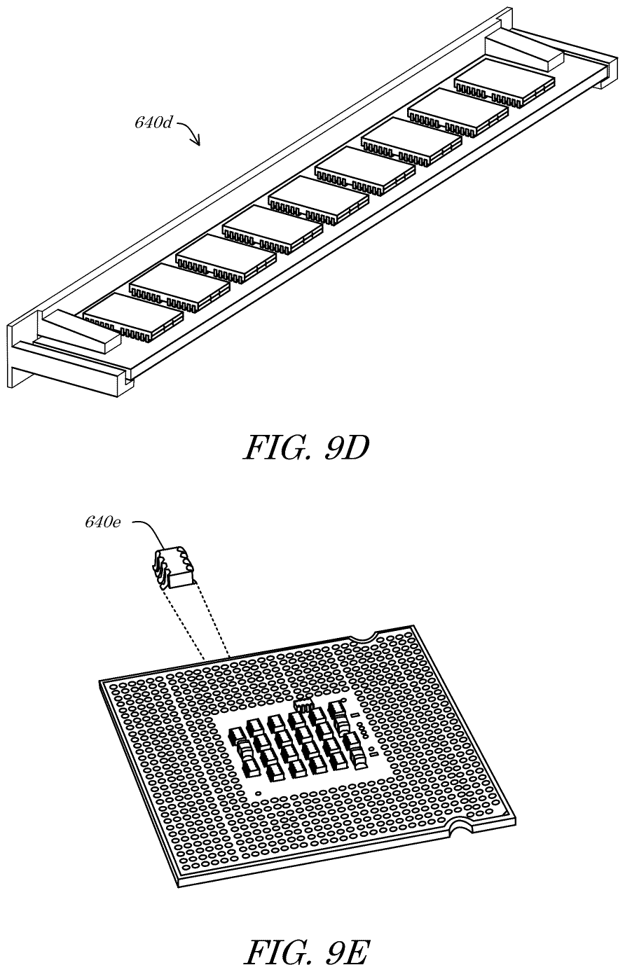

Referring to FIG. 9A, FIG. 9B, FIG. 9C, FIG. 9D, and FIG. 9E, perspective diagrams of exemplary data storage devices 640a-e according to some embodiments are shown. The data storage devices 640a-e may, for example, be utilized to store instructions and/or data such as the trailer maneuvering instructions 542-1 and/or interface instructions 542-2, location data 544-1, movement data 544-2, and/or sensor data 544-3, each of which is presented in reference to FIG. 7 herein. In some embodiments, instructions stored on the data storage devices 640a-e may, when executed by a processor, cause the implementation of and/or facilitate a method in accordance with embodiments herein.

According to some embodiments, the first data storage device 640a may comprise one or more various types of internal and/or external hard drives. The first data storage device 640a may, for example, comprise a data storage medium 646 that is read, interrogated, and/or otherwise communicatively coupled to and/or via a disk reading device 648. In some embodiments, the first data storage device 640a and/or the data storage medium 646 may be configured to store information utilizing one or more magnetic, inductive, and/or optical means (e.g., magnetic, inductive, and/or optical-encoding). The data storage medium 646, depicted as a first data storage medium 646a for example (e.g., breakout cross-section “A”), may comprise one or more of a polymer layer 646a-1, a magnetic data storage layer 646a-2, a non-magnetic layer 646a-6, a magnetic base layer 646a-4, a contact layer 646a-5, and/or a substrate layer 646a-6. According to some embodiments, a magnetic read head 649A may be coupled and/or disposed to read data from the magnetic data storage layer 646a-2.

In some embodiments, the data storage medium 646, depicted as a second data storage medium 646b for example (e.g., breakout cross-section “B”), may comprise a plurality of data points 646b-2 disposed with the second data storage medium 646b. The data points 646b-2 may, in some embodiments, be read and/or otherwise interfaced with via a laser-enabled read head 649B disposed and/or coupled to direct a laser beam through the second data storage medium 646b.

In some embodiments, the second data storage device 640b may comprise a CD, CD-ROM, DVD, Blu-Ray™ Disc, and/or other type of optically-encoded disk and/or other storage medium that is or becomes know or practicable. In some embodiments, the third data storage device 640c may comprise a USB keyfob, dongle, and/or other type of flash memory data storage device that is or becomes know or practicable. In some embodiments, the fourth data storage device 640d may comprise RAM of any type, quantity, and/or configuration that is or becomes practicable and/or desirable. In some embodiments, the fourth data storage device 640d may comprise an off-chip cache such as a Level 2 (L2) cache memory device. According to some embodiments, the fifth data storage device 640e may comprise an on-chip memory device such as a Level 1 (L1) cache memory device.

The data storage devices 640a-e depicted in FIG. 9A, FIG. 9B, FIG. 9C, FIG. 9D, and FIG. 9E are representative of a class and/or subset of computer-readable media that are defined herein as “computer-readable memory” (e.g., non-transitory memory devices as opposed to transmission devices or media). The data storage devices 640a-e may generally store program instructions, algorithms, software engines, code, and/or modules that, when executed by a processing device cause a particular machine to function in accordance with one or more embodiments described herein.

### IV. Rules of Interpretation

Throughout the description herein and unless otherwise specified, the following terms may include and/or encompass the example meanings provided. These terms and illustrative example meanings are provided to clarify the language selected to describe embodiments both in the specification and in the appended claims, and accordingly, are not intended to be generally limiting. While not generally limiting and while not limiting for all described embodiments, in some embodiments, the terms are specifically limited to the example definitions and/or examples provided. Other terms are defined throughout the present description.

Neither the Title (set forth at the beginning of the first page of this patent application) nor the Abstract (set forth at the end of this patent application) is to be taken as limiting in any way as the scope of the disclosed invention(s). Headings of sections provided in this patent application are for convenience only, and are not to be taken as limiting the disclosure in any way.

All definitions, as defined and used herein, should be understood to control over dictionary definitions, definitions in documents incorporated by reference, and/or ordinary meanings of the defined terms. The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

The indefinite articles “a” and “an,” as used herein in the specification and in the claims, unless clearly indicated to the contrary, should be understood to mean “at least one.” This rule applies even within the body of a claim where a first instance of an element utilizes “a” or “an” and a second or subsequent instance of the element necessarily utilizes (e.g., for purposes of proper grammar and required antecedent basis) the definite article “the” to refer to the element. The use of the definite article “the” does not limit the element to a single object merely because it is utilized to refer back to a previous mention of the element. The original reference to the element controls with respect to the plurality (or lack thereof) of the element.

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device. Users may comprise, for example, customers, consumers, product underwriters, product distributors, customer service representatives, agents, brokers, etc.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002@ published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

As utilized herein, the terms “program” or “computer program” may refer to one or more algorithms formatted for execution by a computer. The term “module” or “software module” refers to any number of algorithms and/or programs that are written to achieve a particular output and/or output goal-e.g., a ‘login credentialing’ module (or program) may provide functionality for permitting a user to login to a computer software and/or hardware resource and/or a ‘shipping’ module (or program) may be programmed to electronically initiate a shipment of an object via a known and/or available shipping company and/or service (e.g., FedEX®). The terms “engine” or “software engine” refer to any combination of software modules and/or algorithms that operate upon one or more inputs to define one or more outputs in an ongoing, cyclical, repetitive, and/or loop fashion. Data transformation scripts and/or algorithms that query data from a data source, transform the data, and load the transformed data into a target data repository may be termed ‘data transformation engines’, for example, as they repetitively operate in an iterative manner upon each row of data to produce the desired results.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

It will be understood that various modifications can be made to the embodiments of the present disclosure herein without departing from the scope thereof. Therefore, the above description should not be construed as limiting the disclosure, but merely as embodiments thereof. Those skilled in the art will envision other modifications within the scope of the invention as defined by the claims appended hereto.

1. An automated trailer maneuvering system, comprising:
a trailer; and
a vehicle coupled to the trailer, the vehicle comprising (i) a sensor coupled to have a field of view oriented to encompass an area underneath of the trailer, (ii) an electronic processing device, and (iii) a memory storing instructions that when executed by the processing device result in:
receiving, from the sensor and at a first time, first image data of the area underneath of the trailer;
computing, utilizing the first image data and a mathematical model, a first value for a first metric of the trailer;
moving, by the vehicle, the trailer;
receiving, from the sensor and at a second time, second image data of the area underneath of the trailer;
computing, utilizing the second image data and the mathematical model, a second value for the first metric of the trailer;
computing a difference between the first and second values for the first metric of the trailer; and
guiding, based on the computed difference between the first and second values for the first metric of the trailer, further movement of the trailer.

2. The system according to claim 1, wherein the sensor is coupled to have the field of view oriented to encompass the area underneath of the trailer by selectively deploying the sensor from a first position that does not have the field of view to a second position that does have the field of view.

3. The system according to claim 2, wherein the sensor is deployed via an automatically adjustable sensor mount coupled to a rear of the vehicle.

4. The system according to claim 2, wherein the sensor is deployed in response to a detection of a backing of the vehicle.

5. The system according to claim 1 wherein guiding further movement of the trailer includes identifying one or more obstacles, and determining a probability of the one or more obstacles being in a path of movement of the trailer.

6. The system according to claim 5 wherein identifying one or more obstacles is performed with one or more additional sensors mounted to the vehicle.

7. A method, comprising:
mounting a sensor to a vehicle coupled to a trailer;
obtaining, with the sensor, image data of an area beneath the trailer at one location; and
determining, with the image data, one or more metrics of the trailer;
defining, based at least in part to the one or more metrics of the trailer, a path of movement of the vehicle;
wherein the method is performed at least in part by one or more processors coupled to memory.

8. The method according to claim 7 including maneuvering the trailer with the vehicle based at least in part on the one or more metrics along the path to at least a second location.

9. The method according to claim 8 wherein determining one or more metrics includes computing, utilizing the image data and a mathematical model, an angular relationship of the trailer relative to the vehicle.

10. The method according to claim 8 including:
obtaining, with the sensor, second image data of an area beneath the trailer at the at least a second location; and
determining, with the second image data, the one or more metrics of the trailer.

11. The method according to claim 7 wherein obtaining image data includes capturing with the sensor image data of a rear wheel of the trailer.

12. The method according to claim 7 wherein mounting a sensor includes coupling the sensor to the vehicle.

13. The method according to claim 12 including moving the sensor relative to the vehicle.

14. The method according to claim 13 including mounting the sensor to a sensor mount and wherein moving the sensor includes manipulating the sensor mount to selectively position the sensor at one or more vertical positions relative to the vehicle.

15. The method according to claim 7 wherein the sensor includes one of a LADAR sensor, LIDAR sensor or a stereo camera.

16. The system according to claim 1 wherein guiding further movement of the trailer comprises determining, based at least in part on the computed difference between the first and second values for the first metric of the trailer, a path of movement of the vehicle.

17. The system according to claim 16 wherein the first metric and the second metric of the trailer includes one or more of a position or orientation of the trailer relative to the vehicle.

18. The system according to claim 17 further including altering the path of movement of the vehicle based at least in part on detection of an object within a vicinity of the trailer.

19. The method according to claim 8 wherein the one or more metrics includes one or more of a position or orientation of the trailer relative to the vehicle.

20. The method according to claim 19 further including altering the path of movement of the vehicle based at least in part on detection of an object within a vicinity of the trailer.
